(19) United States
(12) Patent Application Publication
(10) Pub. No.: US 2015/0358885 A1
(43) Pub. Date: Dec. 10, 2015

(54) Balancing Access Point Workloads

(71) Applicant: HEWLETT-PACKARD DEVELOPMENT COMPANY, L.P., Houston, TX (US)

(72) Inventor: Byung Kyu Choi, Roseville, CA (US)

(73) Assignee: HEWLETT-PACKARD DEVELOPMENT COMPANY, L.P., Houston, TX (US)

(21) Appl. No.: 14/762,759

(22) PCT Filed: Jan. 23, 2013
(86) PCT No.: PCT/US13/22672

§ 371 Date: Jul. 22, 2015

(51) Int. Cl. H04W 36/22; H04W 36/00; H04W 28/08

(52) U.S. Cl. CPC H04W 36/22; H04W 28/085; H04W 36/0061

(57) ABSTRACT

Balancing access point workloads includes determining a first access point that uses a first channel of a wireless network is overloaded, receiving instructions that a client device who is using a first channel of the first access point is to switch to a second channel that is associated with a second access point, and instructing the client device to switch from using the first channel to use the second channel.

### BACKGROUND

Many organizations, such as universities and libraries, provide wireless networks to multiple users simultaneously. A network user accesses the wireless network through their mobile client devices, such as laptops, phones, or electronic tablets. These client devices interface with the wireless network through an access point. Generally, large wireless networks will utilize multiple access points to serve large numbers of network users because the capability of each access point is limited.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a virtual aggregated access point according to the principles described herein.

FIG. 2 is a diagram of an example of a method for balancing access point workloads according to the principles described herein.

FIG. 3 is a diagram of an example of a method for balancing access point workloads according to the principles described herein.

FIG. 4 is a diagram of an example of a balancing system according to the principles described herein.

FIG. 5 is a diagram of an example of a balancing system according to the principles described herein.

FIG. 6 is a diagram of an example of a flowchart of a process for balancing access point workloads according to the principles described herein.

### DETAILED DESCRIPTION

Wireless networks that are serving large numbers of network users can experience uneven workload distributions among the access points. Generally, a client device will recognize that an access point is exhibiting signs of being overloaded, and the client device will initiate associating with another access point to interface with the wireless network. The process of re-associating with another access point is usually executed without the knowledge of the network user. First, the wireless device disassociates with the overloaded access point. As a result, the network user becomes disconnected temporarily from the wireless network. Next, the client device will scan for a channel to another access point. When a channel is selected, the client device must be authenticated to have access to the wireless network. In response to being authenticated, the client device is associated with the access point. Finally, the client device can use the access point's information, such as a basic service set identifier (BSSID), a medium access control (MAC) address, and channel information for sending and receiving packets.

Unfortunately, the process of dissociating from the overloaded access point and re-associating with another access point leaves the network user without the use of the wireless network for a matter of seconds. Depending on the programs that the network user is using with the wireless network, such a disconnection from the network can be obvious and annoying.

The principles describe herein include a method for balancing the workload of access points in such a manner that prevents the user from being disconnected from the network. Such a method includes determining that a first access point that uses a first channel of a wireless network is overloaded, receiving instructions that a client device who is using a first channel of the first access point is to switch to a second channel that is associated with a second access point, and instructing the client device to switch from using the first channel to use the second channel. This method is initiated by a device other than the client device. Such a device includes the switch, access point, another device, or combinations thereof. As a result, the client device does not disconnect from the original access point to search for a new access point. Instead, the client device is told that its access point is overloaded and to switch to an identified channel ready for that client device. Thus, rescanning for another channel is eliminated. Further, the client device is not asked to re-authenticate with the other access point. Instead, the client device can seamlessly continue operating on the second access point in a manner that is transparent to the network user.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

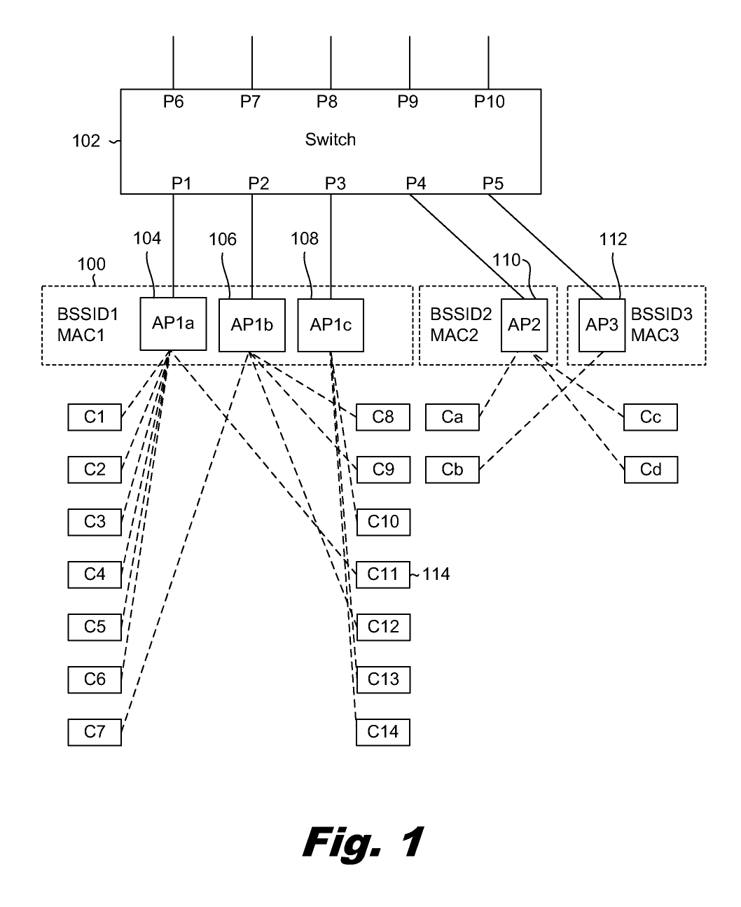

FIG. 1 is a diagram of an example of a virtual aggregated access point (100) according to the principles described herein. In this example, a switch (102) has multiple ports which connect access points with components of the wireless network. In this example, ports 1-5 are in communication with access points while ports 6-10 are in communication with network components. The switch uses a bridge table to track which input ports (ports 1-5) are connected to which output ports (ports 6-10).

The access points (104, 106, 108, 110, 112) are in communication with client devices (C1-C14, Ca-Cd) that are accessing the wireless network. The client devices may be phones, laptops, desktops, electronic tablets, other client devices, or combinations thereof. Access points (104, 106, 108) are grouped together to form a virtual aggregated access point (100) that appears to the client device to have a single BSSID and a single MAC address. The BSSID and the MAC address are used by the client device to send and receive messages with the components of the wireless network. However, to the switch (102), each member access point (104, 106, 108) of the virtual aggregated access point (100) has different BSSIDs and MAC addresses. For these member access points (104, 106, 108), each access point shares a common BSSID and MAC address to communicate with the client devices. However, each access point (104, 106, 108) has a second BSSID and MAC address for communicating with the switch (102). Consequently, the access points (104, 106, 108) translate the BSSIDs and MAC addresses as appropriate for the incoming and outgoing packets. However, each of the access points (104, 106, 108) use independent channels to communicate with the client devices.

Access points (110, 112) are not part of a group of a virtual aggregated access points. These access points (110, 112) appear to the client devices to have independent BSSIDs, independent MAC addresses, and independent channels. The switch (102) uses the same BSSIDs and MAC addresses to communicate with the access points (110, 112) as the client devices use to communicate with the access points (110, 112).

When a client device connects to the wireless network, the client device scans for available wireless channels. If multiple channels are available, the device can select any channel to join. Often, the client device will choose the channel with the strongest radio signal. However, in other examples, other rules are used to determine to which of the available channels to connect. The client device may use a passive scanning mode, where the client device waits for beacon signals from access points within radio reachable distances. In such an example, when the client device receives the beacon signals, the client device can choose which channel to use to connect to the wireless network. In other examples, the client device uses an active mode. In such examples, the client device actively broadcasts probe request messages and collects the corresponding response messages from access points within radio reachable distances.

Scanning is complete when the client device and the selected channel to an access point are synchronized. Upon completion of the scan, the client device is ready for authentication, which occurs when the client device is first connected with the virtual aggregated access point (100) or each time that the client re-associates with access points that are not part of the virtual aggregated access point (100). For future re-associations with other access points within the same virtual aggregated access point, the authentication is not re-executed, as explained in more detail later. Upon the completion of the authentication process, the client device is ready for association.

During the association process, the client device asks the access point to accept the device as a new member of the basic service set (BSS). The access point accepts the join request based on valid authentication results. Upon the completion of association, the client device is ready to send and receive wireless MAC frames to and from the access point for sending and receiving packets.

The process for initially connecting to the wireless network is the same whether the client device chooses to join the wireless network with a channel associated with a member access point (104, 106, 108) associated with the virtual aggregated access point (100) or an access point (110, 112) that is not part of a virtual aggregated access point (100). However, the process for handing off a client from one access point to another access point is different depending on whether the client device is associated with a virtual aggregated access point (100) or not.

For those access points (104, 106, 108) that are part of the virtual aggregated access point (100), the access points (104, 106, 108) themselves determine whether they are overloaded. For example, access point (104) may determine that it is overloaded. In such a situation, access point (104) sends a message to the switch (102) informing the switch (102) that it is overloaded. The switch (102) determines whether the other switches in the virtual aggregated access point (100) are also overloaded. If all of the other access points (106, 108) in the virtual aggregated access point (100) are also overloaded, the switch takes no action. In other examples, the switch (102) will inform the access point (104) that all of the other access points (106, 108) are also overloaded. However, if at least one of the other access points (106, 108) is not overloaded, then the switch (102) chooses one of these access points (106,108) to handoff at least one of the client devices from access point (104).

For this example, the switch (102) chooses access point (106) to handoff a client device. Also, in this example, access point (104) chooses to handoff client device C11 (114). As a result, the switch (102) instructs access point (104) to handoff the client device C11 (114) to access point (106), and informs access point (106) that it is to receive the client device C11 (114). Further, the switch (102) consults with the bridge table to determine which channel that access point (106) is using and gives this information to access point (104). In turn, access point (104) informs the client device C11 (114) to switch from using the channel associated with access point (104) to using the channel being used by access point (106).

Access point (104) reports back to the switch after it has sent the message to the client device C11 (114). Client device C11 (114) switches to the new channel, and in response to receiving the client device C11 (114), access point (106) informs the switch (102) that access point (106) and client device C11 (114) are now associated.

The handoff from access point (104) to access point (106) occurs relatively quickly without disconnecting from the wireless network. The switch (102) informs access point (106) that it is to receive client device C11 (114), thus, access point (106) is ready to receive client device C11 (114) and no further authentication is to be performed. Further, the client device C11 (114) is told which channel to switch to, so client device C11 (114) does not disconnect from the wireless network to determine to which channel to switch. As a result, the handoff is transparent to the network user or at least the disruption to the network is greatly reduced.

The switch (102) is aware of the presence of the virtual aggregated access point (100), the access points (104, 106, 108) that are members of the virtual aggregated access point (100), the BSSID and MAC of the virtual aggregated access point (100), and the channel of each member access points (104, 106, 108). In addition, the switch (106) maintains the bridge table between the member access points (104, 106, 108), the channel of the member access points (104, 106, 108), and the switch port for the member access points (104, 106, 108).

To support the framework of the virtual aggregated access point (100), the member access points (104, 106, 108) provide the programmability of the BSSID and MAC address to be uniform across the members of the same virtual aggregated access point (100). Thus, even though each member access point (104, 106, 108) has its own MAC address and the capability to set up its own BSSID, it has to use the BSSID and MAC values given from the switch (102). Also, the member access points (104, 106, 108) are able to choose different channels from the neighboring member access points (104, 106, 108) within the same virtual aggregated access point (100).

The virtual aggregated access point (100) is transparent to the client device. The channel change request from the member access points (104, 106, 108) to the client device can use standard protocols. So, the virtual aggregated access point (100) is client device friendly.

Neighboring member access points (104, 106, 108) of the virtual aggregated access point (100) choose different channels from its neighbors. Each member access point (104, 106, 108) of the virtual aggregated access point (100) continuously reports its channel information to the switch (102). The virtual aggregated access point (100) may allow handoffs to occur just if one of the member access points (104, 106, 108) is overloaded. However, if all of the member access points (104, 106, 108) are overloaded, then the handoff will not occur.

In some examples, the client device may choose to initiate a handoff. Such a situation may occur if all of the member access points (104, 106, 108) are overloaded. If the client device chooses another channel from the same virtual aggregated access point (100), the handoff automatically utilizes the fast handoff described above. If the client device chooses another access device (110, 112) outside of the virtual aggregated access point (100), the handoff will be done in the framework of the traditional handoff, which is slower and will result in the disconnection of the client device from the wireless network temporarily.

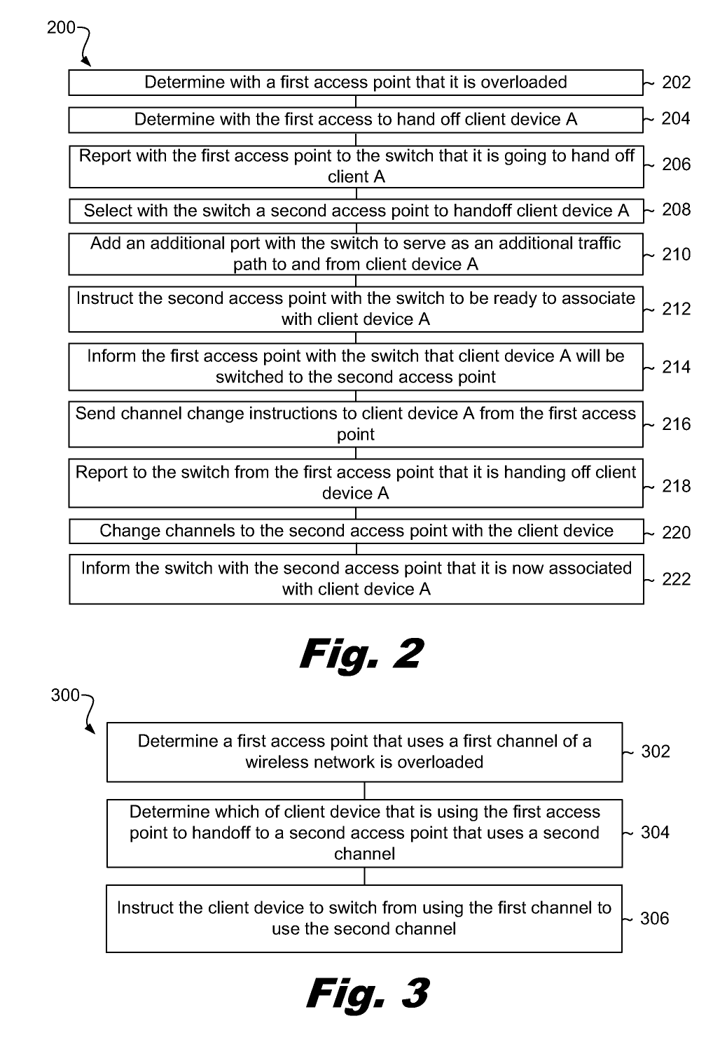

FIG. 2 is a diagram of an example of a method (200) for balancing access point workloads according to the principles described herein. In this example, the method (200) includes determining (202) with a first access point that it is overloaded and determining (204) it wants to handoff client device A. These decisions are reported (206) to the switch. The switch selects (208) a second access point for the first access point to handoff client device A. The switch also adds (210) an additional port to serve as an additional traffic path to and from client device A. The switch further instructs (212) the second access point to be ready to associate with client device A. The switch informs (214) the first access point that client device A will be switched to the second access point.

The first access point sends (216) channel change instructions to client device A from the first access point. The first access point also reports (218) to the switch that it is handing off client device A. The client device will change (220) the channels to the channel used by the second access point. The second access point will inform (222) the switch when the second access point is associated with client device A.

FIG. 3 is a diagram of an example of a method (300) for balancing access point workloads according to the principles described herein. In this example, the method (300) includes determining (302) that a first access point that uses a first channel of a wireless network is overloaded, determining (304) which of the client devices that is using the first access point to handoff to a second access point that uses a second channel, and instructing (306) the client device to switch from using the first channel to use the second channel.

The first and the second access points may be members of a single virtual aggregated access point. Such a virtual aggregated access point causes the BSSID and the MAC address to appear to client devices to be the same for each access point that is a member of the virtual aggregated access point. However, to the switch, the first and the second access points appear to have different BSSIDs and MAC addresses.

In some examples, the second access point is instructed to be ready to associate with the client device. The first access point may send a report to the switch notifying the switch that it is handing off the client device, and the second access point may send a report to the switch indicating that the client device is now associated with it.

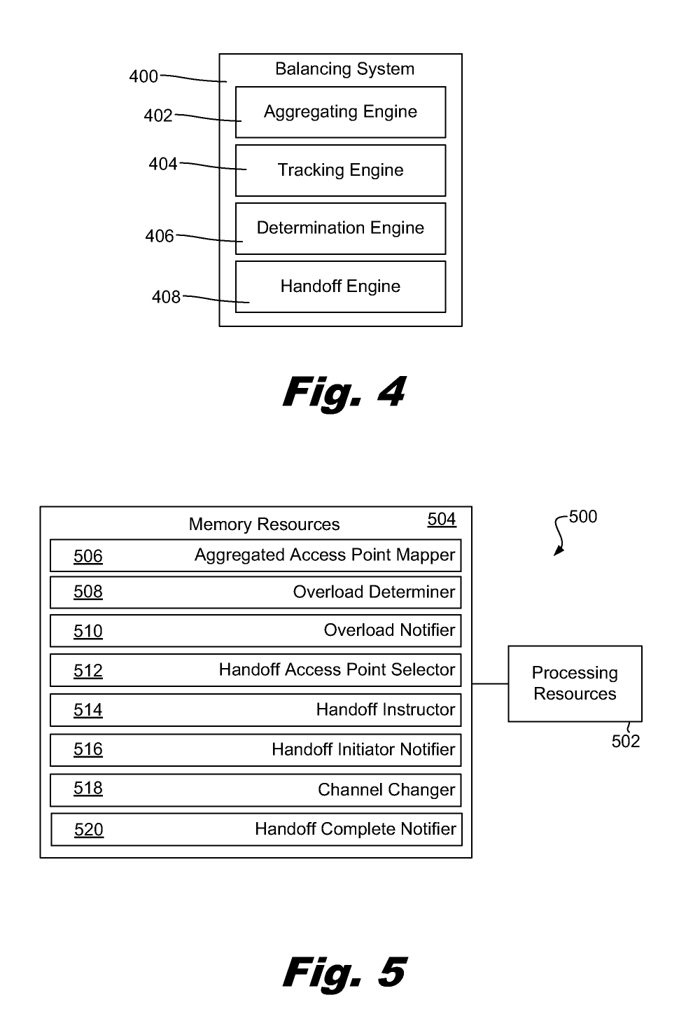

FIG. 4 is a diagram of an example of a balancing system (400) according to the principles described herein. In this example, the balancing system (400) includes an aggregating engine (402), a tracking engine (404), a determination engine (406), and a handoff engine (408). The engines (402, 404, 406, 408) refer to a combination of hardware and program instructions to perform a designated function. Each of the engines (402, 404, 406, 408) may include a processor and memory. The program instructions are stored in the memory and cause the processor to execute the designated function of the engine.

The aggregating engine (402) aggregates the member access points to form the virtual aggregated access point, which functions to the client devices as a single access point. While the virtual aggregated access point appears to the client devices to have a single BSSID and a single MAC address, the virtual aggregated access point communicates with multiple client devices with multiple channels. To the switch, the member access points have independent BSSIDs and MAC addresses.

The tracking engine (404) tracks which channels are in communication with each of the client devices and associated with which access points. The determination engine (406) determines when an access point is overloaded, and the handoff engine (408) orchestrates the handoff between the first and the second access points.

FIG. 5 is a diagram of an example of a balancing system (500) according to the principles described herein. In this example, the balancing system (500) includes processing resources (502) that are in communication with memory resources (504). Processing resources (502) include at least one processor and other resources used to process programmed instructions. The memory resources (504) represent generally any memory capable of storing data such as programmed instructions or data structures used by the balancing system (500). The programmed instructions shown stored in the memory resources (504) include an aggregated access point mapper (506), an overload determiner (508), an overload notifier (510), a handoff access point selector (512), a handoff instructor (514), a handoff initiator notifier (516), a channel changer (518), and a handoff complete notifier (520).

The memory resources (504) include a computer readable storage medium that contains computer readable program code to cause tasks to be executed by the processing resources (502). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The aggregated access point mapper (506) represents programmed instructions that, when executed, cause the processing resources (502) to map which channels are associated with which access points in the virtual aggregated access point and/or which client devices are in communication with each channel. The overload determiner (508) represents programmed instructions that, when executed, cause the processing resources (502) to determine when a member access point in the virtual aggregated access point is overloaded compared to the other member access points. The overload notifier (510) represents programmed instructions that, when executed, cause the processing resources (502) to notify the switch when it is determined that an access point is overloaded.

The handoff access point selector (512) represents programmed instructions that, when executed, cause the processing resources (502) to select which other access point in the virtual aggregate access point should receive the client device to be handed off. The handoff instructor (514) represents programmed instructions that, when executed, cause the processing resources (502) to generate instructions for how to handoff the client device to the selected access point. The instructions will be sent to the overloaded access point, who in turns instructs the client device about the handoff. The handoff initiator notifier (514) represents programmed instructions that, when executed, cause the processing resources (502) to notify the switch when the overloaded access point sends the handoff instructions to the client device.

The channel changer (518) represents programmed instructions that, when executed, cause the processing resources (502) to change the channel used by the client device from the channel associated with the overloaded access point to the channel associated with the selected access point. The handoff complete notifier represents programmed instructions that, when executed, cause the processing resources (502) to notify the switch when the client device is using the channel associated with the selected access point. In response to the completion notification, the aggregated access point mapper (506) makes changes to the bridge table to reflect the changes.

Further, the memory resources (504) may be part of an installation package. In response to installing the installation package, the programmed instructions of the memory resources (504) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (502) and the memory resources (504) are located within the same physical component, such as a server, or a network component. The memory resources (504) may be part of the physical component's main memory, caches, registers, non-volatile memory, or elsewhere in the physical component's memory hierarchy. Alternatively, the memory resources (504) may be in communication with the processing resources (502) over a network. Further, the data structures, such as the libraries and may be accessed from a remote location over a network connection while the programmed instructions are located locally. Thus, the balancing system (500) may be implemented on a user device, on a server, on a collection of servers, or combinations thereof.

The balancing system (500) of FIG. 5 may be part of a general purpose computer. However, in alternative examples, the balancing system (500) is part of an application specific integrated circuit.

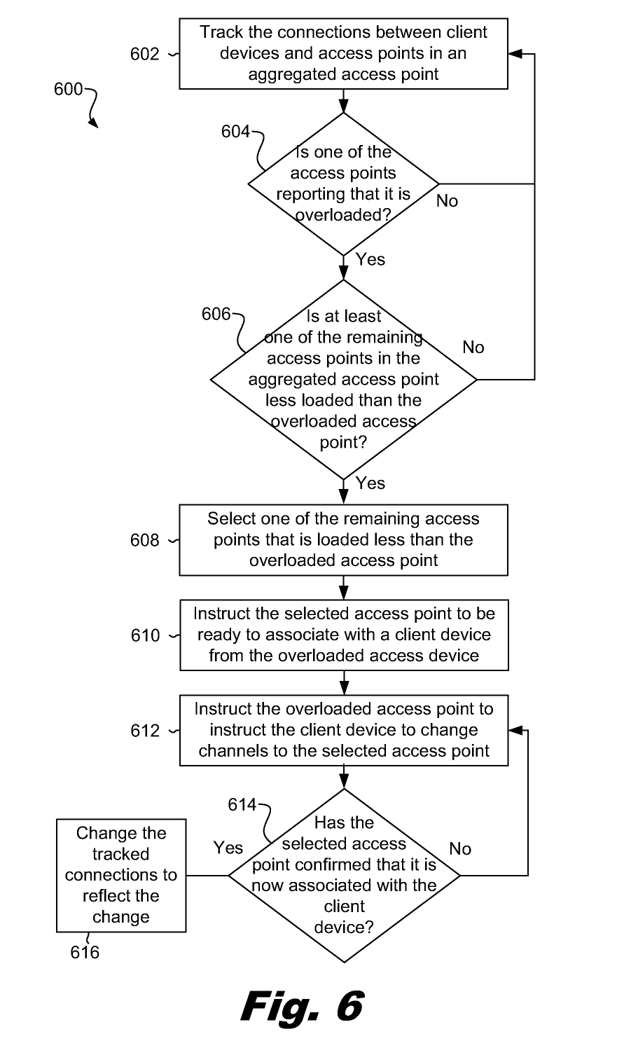

FIG. 6 is a diagram of an example of a flowchart (600) of a process for balancing access point workloads according to the principles described herein. In this example, the process includes tracking (602) the connections between client devices and access points in an aggregated access point, and determining (604) whether one of the access points is reporting that it is overloaded. If none of the access points are reporting that they are overloaded, then the process continues to track (602) the connections.

If one of the access points is reporting that it is overloaded, the process determines (606) whether at least one of the remaining access points in the virtual aggregated access point is less loaded than the overloaded access point. If none of the remaining access points are less loaded (i.e., all of the access points are overloaded), then the process continues to track the connections. If all of the access points are overloaded, then the workload among the access points is balanced. If the workload is balanced, but the access points are still overloaded, then the process may include a wait period to recheck to determine if one of the member access points frees up.

If an access point is less loaded than the overloaded access point, the process continues by selecting (608) one of the remaining access points that is loaded less than the overloaded access point to receive a client device from the overloaded access point. The selected access point is instructed (610) to be ready to associate with a client device from the reporting access device. Also, the overloaded access point is instructed (612) to instruct the client device to change the channel from a channel used by the overloaded access point to a channel used by the selected access point. The process also includes determining (614) whether the selected access point has confirmed that it is now associated with the client device. If not, the selected access point is re-instructed (612). If the selected access point has reported that it is now associated with the client device, then the switch changes (616) the tracked connections to reflect the changes.

While the examples above have been described with reference to specific types of switches, client devices, and access points, any appropriate switch, client device, and/or access point may be used in accordance with the principles described herein. Further, while the operation of the access points not associated with the virtual aggregated access points have been described in relation to the above examples, these access points may handle the handoff with any appropriate mechanism and/or protocol.

While the examples above have been described with reference to a specific virtual aggregated access point and an associated architecture, any appropriate virtual aggregated access points with architectures, layouts, and protocols varying from the examples above may be used in accordance with the principles described herein. While the examples above have been described with reference to specific wireless networks, any appropriate type of network may be used in accordance with the principles described herein.

While the examples above have been described with different components performing different functions, any appropriate device may perform any appropriate function to accomplish the handoff. For example, the switch may determine when an access point is overloaded, determine to which access point to handoff a client device, determine which client device to handoff, instruct the receiving access point to be ready to receive the client device, instruct the client device to change channels, other functions, or combinations thereof. However, in other examples, one of the access points or another device may perform these functions. In other examples, the devices that perform these functions are distributed across multiple components.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for balancing access point workloads, comprising;
determining a first access point that uses a first channel of a wireless network is overloaded;
receiving instructions that a client device who is using a first channel of said first access point is to switch to a second channel that is associated with a second access point; and
instructing said client device to switch from using said first channel to use said second channel.

2. The method of claim 1, wherein said first and second access points appear to said client device to have a single basic service set identifier (BSSID).

3. The method of claim 1, wherein said first and second access points appear to said client device to have a single medium access control (MAC) addresses.

4. The method of claim 1, wherein said first and second access points appear to a switch to have different basic service set identifiers (BSSIDs).

5. The method of claim 1, wherein said first and second access points appear to a switch to have a different medium access control (MAC) addresses.

6. The method of claim 1, wherein said first and second access points are members of a single virtual aggregated access point.

7. The method of claim 1, further comprising instructing said second access point to be ready to associate with said client device.

8. The method of claim 1, further comprising sending a report to a switch that said client device is handing off from said first access point.

9. The method of claim 1, further comprising sending a report to a switch that said client device is associated with said second access point.

10. A system for balancing access point workloads, comprising;
an aggregating engine to aggregate multiple access points communicating with a common switch to appear to client devices to have a common basic service set identifier (BSSID) and a common medium access control (MAC) address;
a tracking engine to track which of said client devices is associated with which of said multiple access points; and
a handoff engine to initiate handing off one of said client devices from a first access point of said multiple access points to a second access point of said multiple access points.

11. The system of claim 10, wherein said system further comprises a determination engine that determines when to initiate a handing off process.

12. The system of claim 10, wherein said aggregating engine allows said multiple access points to appear to said common switch to have independent BSSIDs and MAC addresses.

13. A computer program product for balancing access point workloads, comprising:
a non-transitory computer readable storage medium, said non-transitory computer readable storage medium comprising computer readable program code embodied therewith, said computer readable program code comprising program instructions that, when executed, causes a processor to:
aggregate multiple access points communicating with a common switch to appear as a single access point to multiple client devices;
determine that a first access point of said multiple access points that uses a first channel of a wireless network is overloaded;
determine which of said multiple client devices using said first access point to handoff to a second access point of said multiple access points that uses a second channel; and
initiate a handoff process from said first access point to said second access point.

14. The computer program product of claim 13, further comprising computer readable program code comprising program instructions that, when executed, causes said processor to allow said multiple access points to appear to said common switch to have independent BSSIDs and MAC addresses.

15. The computer program product of claim 13, further comprising computer readable program code comprising program instructions that, when executed, causes said processor to track which of said multiple client devices is associated with which of said multiple access points.
